(19) United States
(12) Patent Application Publication
(10) Pub. No.: US 2008/0257622 A1
(43) Pub. Date: Oct. 23, 2008

(54) Motor Vehicle Comprising a Solar Module

(75) Inventors: Helmut Teschner, Landsberg/Lech (DE); Noureddine Khelifa, Munchen (DE); Rupert Kogler, Grafelfing (DE)

Correspondence Address: DICKINSON WRIGHT PLLC, 1901 L. STREET NW, SUITE 800, WASHINGTON, DC, 20036, US

(73) Assignee: WEBASTO AG, Stockdorf (DE)

(21) Appl. No.: 12/097,424

(22) PCT Filed: Jan. 22, 2007
(86) PCT No.: PCT/DE2007/000138

§ 371 Date: Jun. 13, 2008

(30) Foreign Application Priority Data
Jan. 24, 2006 (DE) 10 2006 003 424.4

(51) Int. Cl. B60K 1/00; B60H 1/00

(52) U.S. Cl. 180/65.4

(57) ABSTRACT

The invention relates to a mortor vehicle comprising an air-conditioning unit (10) that is provided with an electrically operated compressor (12). Said motor vehicle further comprises a generator (16) which can be operated by a vehicle drive unit (14) in order to generate electric power, a battery (18) that can be charged by means of the electric power generated by the generator, and a solar module (22) for generating electric power, the motor vehicle especially being a hybrid vehicle. According to the invention, another battery is provided which can be charged using the power generated by the solar module (22) while the electrically operated compressor (12) can be operated using power stored in the first battery (18) and/or power stored in the additional battery (20).

The invention relates to a motor vehicle comprising an air-conditioning system which has an electrically operated compressor, a generator, which can be operated by a vehicle drive, for generating electrical power, a battery which can be charged by the electrical power generated by the generator, and a solar module for generating electrical power. The invention relates, in particular, to a motor vehicle of this type comprising a hybrid drive which has one vehicle drive based on fossil fuels and one vehicle drive based on electrical power.

Since the power required for conventional air-conditioning of a motor vehicle interior is provided by the internal combustion engine of the motor vehicle, it is necessary to find other concepts for air-conditioning when a vehicle is parked and the internal combustion engine is at a standstill. A useful approach is disclosed in DE 199 03 769 A1. Said document describes using the electrical power provided by a solar module to operate fans for ventilating the passenger compartment. Solar power which is not required for operating the fans is temporarily stored in the vehicle battery. The motor-vehicle air-conditioning system can then be operated following this solar-powered ventilation, with an electrically operated compressor being provided for this purpose. As a result, operation of the vehicle air-conditioning system is started at a lower temperature level than would be the case without solar-powered ventilation. In this way, it is possible to adjust the temperature of the motor vehicle to a tolerable level before operation, that is to say before a person enters said motor vehicle, even on hot days.

In concepts of this type which employ solar power, the power of the solar-power system, the storage capacity of the vehicle battery, the efficiency of the vehicle battery and the electrical power consumption during the various modes of operation involved, amongst other things, have to be taken into account. Particularly on the basis of these variables, it is desirable to use the improvement potential for air-conditioning when a vehicle is parked on the basis of a solar power supply system and to optimize air-conditioning when a vehicle is parked.

Particular attention is to be paid to feeding the electrical power generated by the solar module. This involves, in particular, adapting the various voltages generated, stored and required in the motor vehicle and efficiently storing the generated power.

The invention is based on the object of feeding the power provided by a solar module in a suitable manner to the electrical system of a motor vehicle, particularly in the case of a vehicle with a hybrid drive.

This object is achieved by the features of the independent claims. Advantageous embodiments of the invention are specified in the dependent claims.

According to a first aspect of the invention, said invention builds on the generic motor vehicle in that a further battery is provided which can be charged by the power generated by the solar module, and in that the electrically operated compressor can be operated by power stored in the first battery and/or in the further battery. In this way, it is possible to store the electrical power provided by the solar module independently of the power which is provided in a conventional manner by the generator of the vehicle.

Therefore, no provisions need to be made which permit the power provided by the solar module to be fed to the normal vehicle battery. Instead, a conventional system can be additionally fitted with a solar module and an additional battery in a simple manner.

This is useful particularly when the further battery has a different operating voltage than the battery which can be charged by the generator, and when the operating voltage of the further battery substantially corresponds to the voltage generated directly or indirectly by the solar module. The operating voltage of the further battery can therefore be matched directly to the requirements of the load predominantly supplied with power by this further battery. If, for example, the electrical compressor of the air-conditioning system is operated in a particularly efficient manner on the basis of an operating voltage of 48 V, the electrical power provided by the solar module can be adjusted to this voltage value by a DC/DC converter and be stored in a power with such an operating voltage from the outset. If the electrical compressor is operated by the normal vehicle battery, which has an operating voltage of 12 V for example, it is thus possible to transform the voltage to the desired voltage level by means of a DC/DC converter.

According to a second aspect of the invention, said invention relates to a motor vehicle comprising a hybrid drive, it being possible for the battery to be charged by the power generated by the solar module, and it being possible for the electrically operated compressor to be operated by power stored in the battery. Motor vehicles with hybrid drives, that is to say with one vehicle drive based on fossil fuels and one vehicle drive based on electrical power, employ as standard a sophisticated system for providing suitable voltages. For example, batteries are provided which operate at voltage values of 200 V. In order to drive the motor vehicle with the power stored in the batteries, said power is frequently transformed into an AC voltage at a suitable voltage level by means of an inverter/converter. The electrical system of a hybrid vehicle therefore provides good conditions for including the electrical power provided by the solar module in a suitable manner, in particular by virtue of the use of additional and/or existing inverters/converters and DC/DC converters.

It is particularly preferred for the vehicle drive based on electrical power and the electrically operated compressor to be supplied with power by the same battery 18. The vehicle can therefore manage with a single battery or with a single battery pack using suitable inverters/converters or converters.

It is useful in this connection for means to be provided which match the voltage provided by the generator and/or the solar module to the operating voltage of the battery. Even if it is feasible, in principle, for the solar module and the generator to supply voltages which can be applied directly to the battery, it is generally useful and necessary to operate the generator and the solar module in the range of their optimum operating voltages and to match them to the battery voltage by means of simple converters and/or inverters/converters.

For comparable reasons, provision is made for means to be provided which match the voltage tapped off from the battery to the operating voltage of at least one load. The invention also relates to a power supply system for a motor vehicle according to the invention.

The invention will now be explained by way of example with reference to the accompanying drawings of particularly preferred embodiments.

In the drawings:

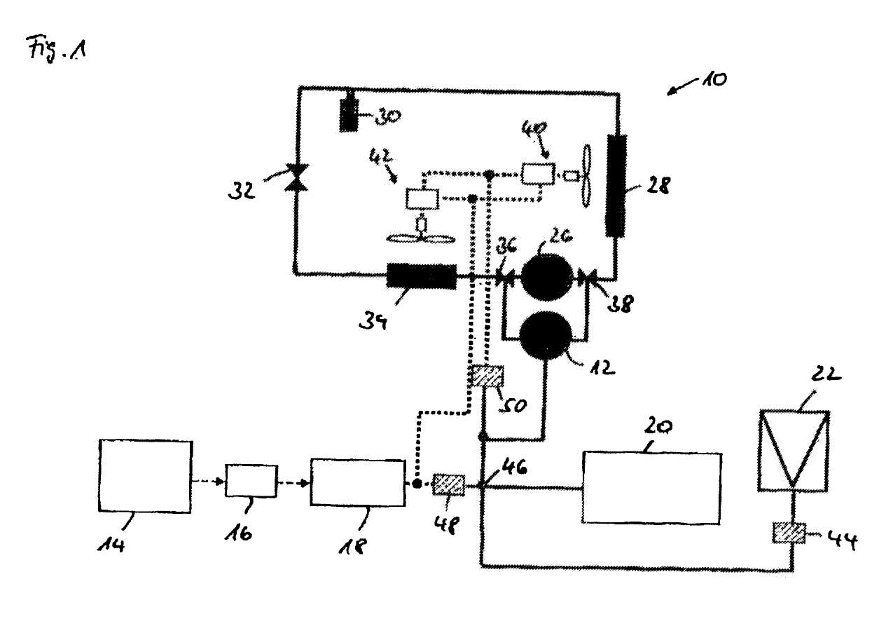

FIG. 1 shows a schematic illustration of a first embodiment of a power supply system according to the invention and vehicle components connected to said power supply system;

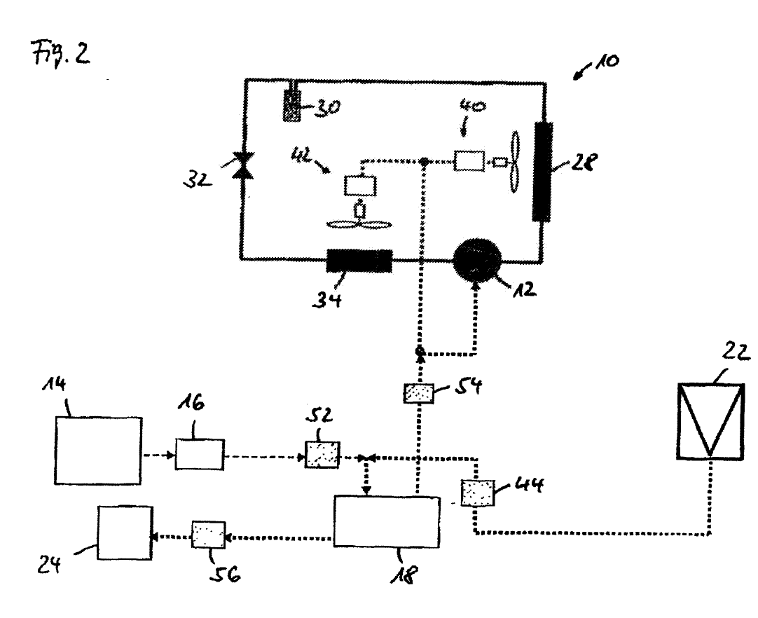

FIG. 2 shows a schematic illustration of a second embodiment of a power supply system according to the invention and vehicle components connected to said power supply system;

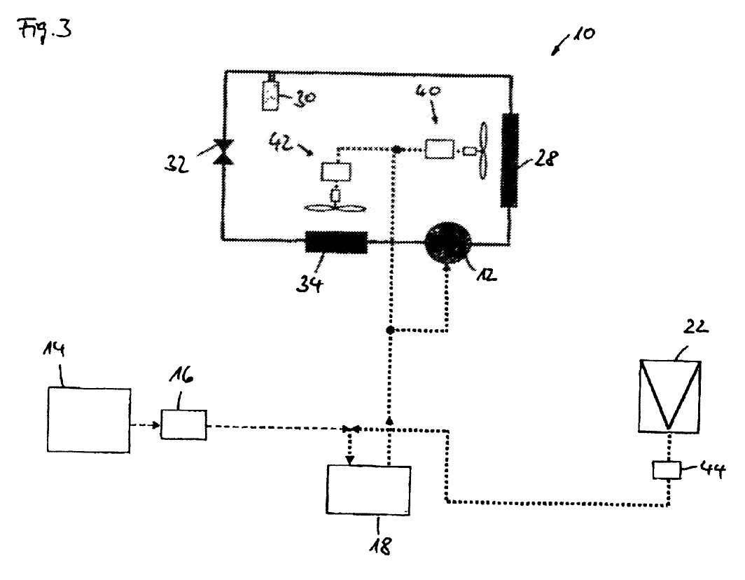

FIG. 3 shows a schematic illustration of a third embodiment of a power supply system according to the invention and vehicle components connected to said power supply system;

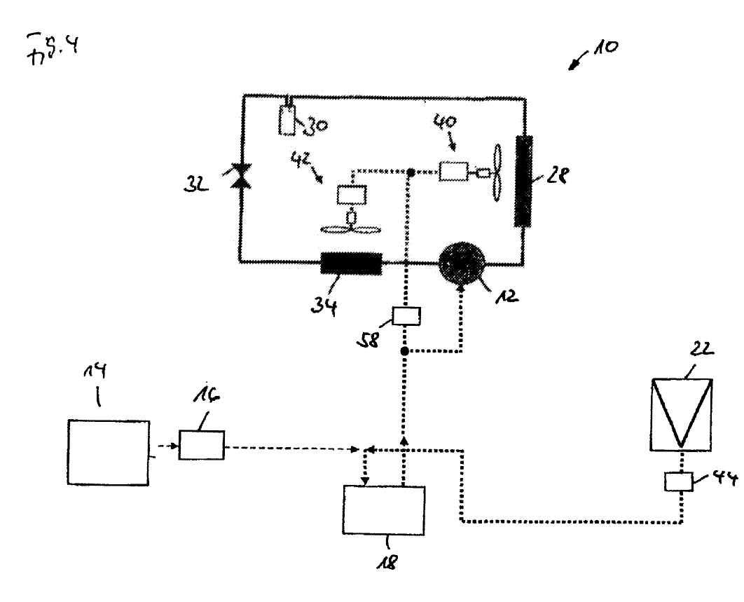

FIG. 4 shows a schematic illustration of a fourth embodiment of a power supply system according to the invention and vehicle components connected to said power supply system;

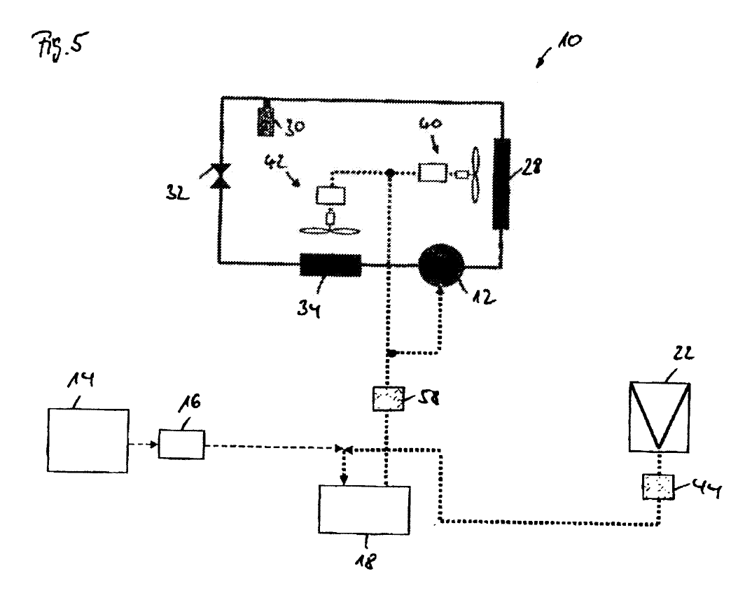

FIG. 5 shows a schematic illustration of a fifth embodiment of a power supply system according to the invention and vehicle components connected to said power supply system;

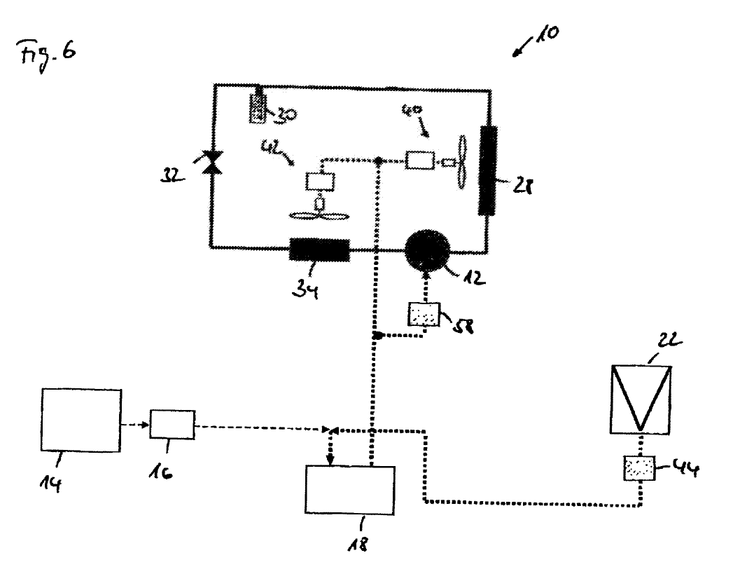

FIG. 6 shows a schematic illustration of a sixth embodiment of a power supply system according to the invention and vehicle components connected to said power supply system;

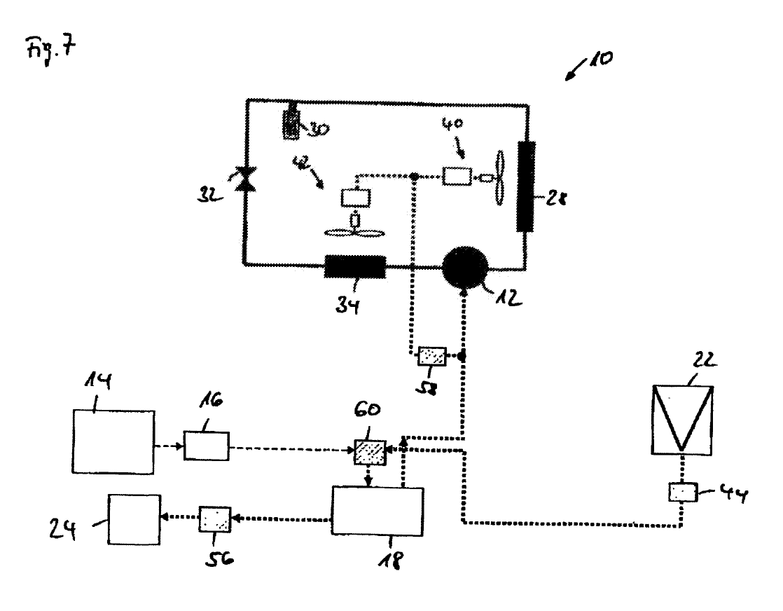

FIG. 7 shows a schematic illustration of a seventh embodiment of a power supply system according to the invention and vehicle components connected to said power supply system.

In the following description of the drawings, identical reference symbols denote identical or comparable components.

FIG. 1 shows a schematic illustration of a first embodiment of a power supply system according to the invention and vehicle components connected to said power supply system. An air-conditioning system 10 of a motor vehicle comprises, as essential components, an electrically operated compressor 12, a mechanically operated compressor 26, a capacitor 28, a collector 30, an expansion valve 32, and an evaporator 34. Said components form a refrigeration circuit which can selectively contain the mechanical compressor 26 or the electrical compressor 12, with controllable valves 36, 38 being provided to switch over between said operating options. An electrically operated blower 40 is provided in order to dissipate the heat produced at the capacitor 28. An electrically operated blower 42 is provided in order to supply air to be cooled to the evaporator.

A vehicle drive 14 drives a generator 16. Said generator is connected to a battery 18 in order to charge said battery.

Also provided is a solar module 22 which is connected to a circuit node 46 via a DC/DC converter 44, with this circuit node 46 being connected both to the power supply means of the air-conditioning system 10 and to a further battery 20.

The present system is now designed such that the DC/DC converter 44 provides a different voltage than the generator 16. For example, the generator usually provides a voltage of 12 V, whereas the DC/DC converter 44 converts the voltage provided by the solar module 22 to a voltage value of 42 V. This may be useful when the electrical compressor 12 which is supplied with power by the solar module 22 or by the further battery 20 is to be supplied with an operating voltage of 42 V. In this case, the voltage provided by the further battery 20 can be supplied directly to the electrical compressor 12. In order to likewise permit the power which is generated by the battery 18, which is charged by the generator 16, to be used to drive the electrical compressor, a further DC/DC converter 48 is provided between the battery 18 and the circuit node 46. The power stored in the battery 18 can be used without changing the voltage value in order to supply electrical power to the blowers 40, 42. If the supply of power to these blowers 40, 42 is taken over by the power stored in the further battery 20 or the electrical voltage provided by the DC/DC converter 44, that is to say by the voltage applied to the circuit node 46, a DC/DC converter 50 is provided for this purpose. Said DC/DC converter converts the voltage corresponding to the operating voltage of the further battery 20 to a value which corresponds to the operating voltage of the battery 18.

The result is therefore a system which has two batteries 18, 20, with each battery 18, 20 being able to undertake all the power supply tasks relating to the air-conditioning system. The battery 18 which can be charged by the generator 16 can be designed in a conventional manner. The further battery 20 can be selected depending on the operating voltage of the compressor, in particular with an increased operating voltage for providing an increased power. Instead of a simple DC/DC converter 48 between the battery 18 and the circuit node 46, a device can also be provided which permits the battery 18 to be charged by the power provided by the solar module 22.

With regard to their interaction, the components illustrated in FIG. 1 can be controlled partly by an electronic control means. This relates, in particular, to the electrical compressor 12, the valves 36, 38, the blowers 40, 42 and the DC/DC converters 44, 48, 50.

FIG. 2 shows a schematic illustration of a second embodiment of a power supply system according to the invention and vehicle components connected to said power supply system. In contrast to the system according to FIG. 1, the air-conditioning system 10 illustrated here is provided with only one single compressor, specifically an electrically operated compressor 12. Such a configuration of the air-conditioning system is suitable, in particular, in hybrid vehicles since hybrid vehicles contain an electrical system which can provide adequate power for satisfactory operation of the air-conditioning system. In a hybrid vehicle of this kind, the voltage provided by the generator 16 is adjusted to the operating voltage of a battery 18 or a battery pack by a DC/DC converter 52. This operating voltage may be, for example, approximately 200 V. The power stored in the battery 18 can be supplied firstly to an electrical vehicle drive 24, this generally being performed via an inverter/converter 56 which generates a three-phase AC voltage from the DC voltage. However, the power stored in the battery 18 can also be supplied to the air-conditioning system 10, this being performed via a component 54 which is designed as an inverter/converter or DC/DC converter. In addition to charging by the generator 16, the battery 18 can also be charged by the solar module 22 via a DC/DC converter 44.

In the embodiment illustrated in connection with FIG. 2, the electrical compressor 12 and the blowers 40, 42 can be operated with the same voltage.

FIG. 3 shows a schematic illustration of a third embodiment of a power supply system according to the invention and vehicle components connected to said power supply system. The embodiment illustrated here is comparable to the variant shown in FIG. 2, with said embodiment being simplified with regard to the number of components involved. This is achieved by it being possible for the voltage which is provided by the generator 16 to be supplied directly to the battery 18, like the voltage provided by the DC/DC converter 44 connected downstream of the solar module 22. Furthermore, the voltage stored in the battery 18 can be supplied directly to the electrical components of the air-conditioning system 10, that is to say to the blowers 40, 42 and to the electrical compressor 12. A condition for this simplification is that the operating voltages of the components involved are matched to one another by, for example, using a battery with an operating voltage of 42 V which can be used ideally directly by the electrical compressor 12 of the air-conditioning system 10. In the case of an operating voltage of the battery 18 of 42 V, a further battery with a higher voltage is provided for the electric vehicle drive of the hybrid vehicle, the electric vehicle drive not being illustrated here for this reason. If, however, the battery 18 meets the condition for supplying power to the electric vehicle drive, the battery 18 may be the sole battery.

FIG. 4 shows a schematic illustration of a fourth embodiment of a power supply system according to the invention and vehicle components connected to said power supply system. The system shown here represents a modification to the system illustrated in FIG. 3. A component 58 which may be realized as a DC/DC converter or else as an inverter/converter is additionally provided in order to thus be able to provide different voltages to the electrical compressor 12 and to the further electrical components of the air-conditioning system 10, that is to say in particular to the blowers 40, 42. It is therefore possible, for example, to design the battery 18 as a 42 V battery, with this voltage being directly supplied to the electrical compressor 12, whereas the blowers 40, 42 can operate in a conventional manner with an operating voltage of 12 V.

FIG. 5 shows a schematic illustration of a fifth embodiment of a power supply system according to the invention and vehicle components connected to said power supply system. This represents a further modification of the embodiment according to FIG. 3. A component 58, which can be designed as an inverter/converter or as a DC/DC converter, is connected between the battery 18 and the electrical components of the air-conditioning system 10, that is to say in particular both the electrical compressor 12 and the blowers 40, 42. A solution of this kind may be expedient when the battery 18 is designed, for example, as a 12 V or 42 V battery and the electrical compressor operates, for example, with an operating voltage of 110 V or 220 V, with the operating voltages of the blowers 40, 42 corresponding.

FIG. 6 shows a schematic illustration of a sixth embodiment of a power supply system according to the invention and vehicle components connected to said power supply system. In the currently illustrated embodiment, in contrast to FIG. 5, the blowers 40, 42 can be operated with the battery voltage of, for example, 12 V or 48 V, whereas the voltage supplied to the electrical compressor 12 can be converted to, for example, 110 V.

FIG. 7 shows a schematic illustration of a seventh embodiment of a power supply system according to the invention and vehicle components connected to said power supply system. The embodiment illustrated here is comparable to the embodiment according to FIG. 2. However, in contrast to FIG. 2, the power provided by the solar module 22 is supplied to the battery 18 via the same component 60, it being possible for said component 60 to be, for example, an inverter/converter or, in the simplest case, a DC/DC converter. The DC/DC converter 44 which is mounted downstream of the solar module 22 may also be dispensed with. In the present case, the battery 18 is, for example, again designed as a battery arrangement with an operating voltage of approximately 200 V, so that the voltage can be supplied to an electric vehicle drive 24 via an inverter/converter 56. The voltage can also be used directly to operate an electrical compressor 12. The blowers 40, 42 are preferably supplied with a lower voltage which is provided by the interconnection of a component 58, it being possible for said component to be designed as an inverter/converter or DC/DC converter.

The compressors or compressor combinations (FIG. 1) mentioned in conjunction with the described embodiments can also be realized as hybrid compressors, that is to say as a single compressor which can be driven selectively either mechanically or electrically.

The features of the invention disclosed in the above description, in the drawings and in the claims may be essential for implementing the invention both on their own and in any desired combination.

### List of Reference Symbols:

10 Air-conditioning system
12 Electrical compressor
14 Vehicle drive, fuel
16 Generator
20 Battery
22 Battery
24 Solar module
26 Vehicle drive, electric
28 Mechanical compressor
30 Capacitor
32 Collector
32 Expansion valve
34 Evaporator
36 Valve
38 Valve
40 Blower
42 Blower
44 DC/DC converter
46 Circuit node
48 DC/DC converter
50 DC/DC converter
52 DC/DC converter
54 Inverter/converter or DC/DC converter
56 Inverter/converter
58 Inverter/converter or DC/DC converter
60 Inverter/converter or DC/DC converter

1. A motor vehicle comprising:
an air-conditioning system which has an electrically operated compressor,
a generator, which can be operated by a vehicle drive, for generating electrical power,
a battery which can be charged by the electrical power generated by the generator, and
a solar module for generating electrical power, characterized
in that a further battery is provided which can be charged by the power generated by the solar module, and
in that the electrically operated compressor can be operated by power stored in the battery which can be charged by the generator and/or in the further battery.

2. The motor vehicle of claim 1, characterized
in that the further battery has a different operating voltage than the battery which can be charged by the generator, and
in that the operating voltage of the further battery substantially corresponds to the voltage generated directly or indirectly by the solar module.

3. A motor vehicle comprising
a hybrid drive which has one vehicle drive based on fossil fuels and one vehicle drive based on electrical power,
an air-conditioning system which has an electrically operated compressor,
a generator, which can be operated by a vehicle drive, for generating electrical power,
a battery which can be charged by the electrical power generated by the generator, and
a solar module for generating electrical power,
it being possible for the battery to be charged by the power generated by the solar module, and
it being possible for the electrically operated compressor to be operated by power stored in the battery.

4. The motor vehicle of claim 3, characterized in that the vehicle drive based on electrical power and the electrically operated compressor are supplied with power by the same battery.

5. The motor vehicle of claim 3, characterized in that means are provided which match the voltage provided by the generator and/or the solar module to the operating voltage of the battery.

6. The motor vehicle of claim 3, characterized in that means are provided which match the voltage tapped off from the battery to the operating voltage of at least one load.

7. A power supply system for a motor vehicle.
